(19) United States
(12) Patent Application Publication
(10) Pub. No.: US 2014/0192158 A1
(43) Pub. Date: Jul. 10, 2014

(54) Stereo Image Matching

(71) Applicant: MICROSOFT CORPORATION, Redmond, WA (US)

(72) Inventors: Oliver Whyte, Seattle, WA (US); Adam G. Kirk, Redmond, WA (US); Shahram Izadi, Cambridge (GB); Carsten Rother, Cambridge (GB); Michael Bleyer, Seattle, WA (US); Christoph Rhemann, Cambridge (GB)

(73) Assignee: Microsoft Corporation, Redmond, WA (US)

(21) Appl. No.: 13/733,911

(22) Filed: Jan. 4, 2013

(51) Int. Cl. G06K 9/62; H04N 13/02

(52) U.S. Cl. CPC G06K 9/6201; H04N 13/02
USPC 348/46; 382/154

(57) ABSTRACT

The description relates to stereo image matching to determine depth of a scene as captured by images. More specifically, the described implementations can involve a two-stage approach where the first stage can compute depth at highly accurate but sparse feature locations. The second stage can compute a dense depth map using the first stage as initialization. This improves accuracy and robustness of the dense depth map.

### BACKGROUND

Three dimensional (3-D) information about a scene can be useful for many purposes, such as gesture detection, 3-D video conferencing, and gaming, among others. 3-D information can be derived from stereo images of the scene. However, current techniques for deriving this information tend to work well in some scenarios but not so well in other scenarios.

### SUMMARY

The described implementations relate to stereo image matching to determine depth of a scene as captured by images. More specifically, the described implementations can involve a two-stage approach where the first stage can compute depth at highly accurate but sparse feature locations. The second stage can compute a dense depth map using the first stage as initialization. This improves accuracy and robustness of the dense depth map. For example, one implementation can utilize a first technique to determine 3-D locations of a set of points in a scene. This implementation can initialize a second technique with the 3-D locations of the set of points. Further, the second technique can be propagated to determine 3-D locations of other points in the scene.

The above listed examples are intended to provide a quick reference to aid the reader and are not intended to define the scope of the concepts described herein.

### BRIEF DESCRIPTION OF THE DRAWINGS

The accompanying drawings illustrate implementations of the concepts conveyed in the present document. Features of the illustrated implementations can be more readily understood by reference to the following description taken in conjunction with the accompanying drawings. Like reference numbers in the various drawings are used wherever feasible to indicate like elements. Further, the left-most numeral of each reference number conveys the Figure and associated discussion where the reference number is first introduced.

FIGS. 1-5 show 3-D mapping systems in accordance with some implementations of the present concepts.

FIGS. 6-7 are flowcharts of 3-D mapping techniques in accordance with some implementations of the present concepts.

FIGS. 8-9 show orders in which propagation of pixels in images can be performed in accordance with some implementations.

### DETAILED DESCRIPTION

### Overview

The description relates to stereo matching to determine depth of a scene as captured by images. Stereo matching of a pair of left and right input images can find correspondences between pixels in the left image and pixels in the right image. Depth maps can be generated based upon the stereo matching. Briefly, the present implementations can utilize a first technique to accurately determine depths of seed points relative to a scene. The seed points can be utilized to initialize a second technique that can determine depths for the remainder of the scene. Stated another way, the seed points can be utilized to guide selection of potential minimum and maximum depths for a bounded region of the scene that includes individual seed points. This initialization can enhance the accuracy of the depth results produced by the second technique.

### First System Example

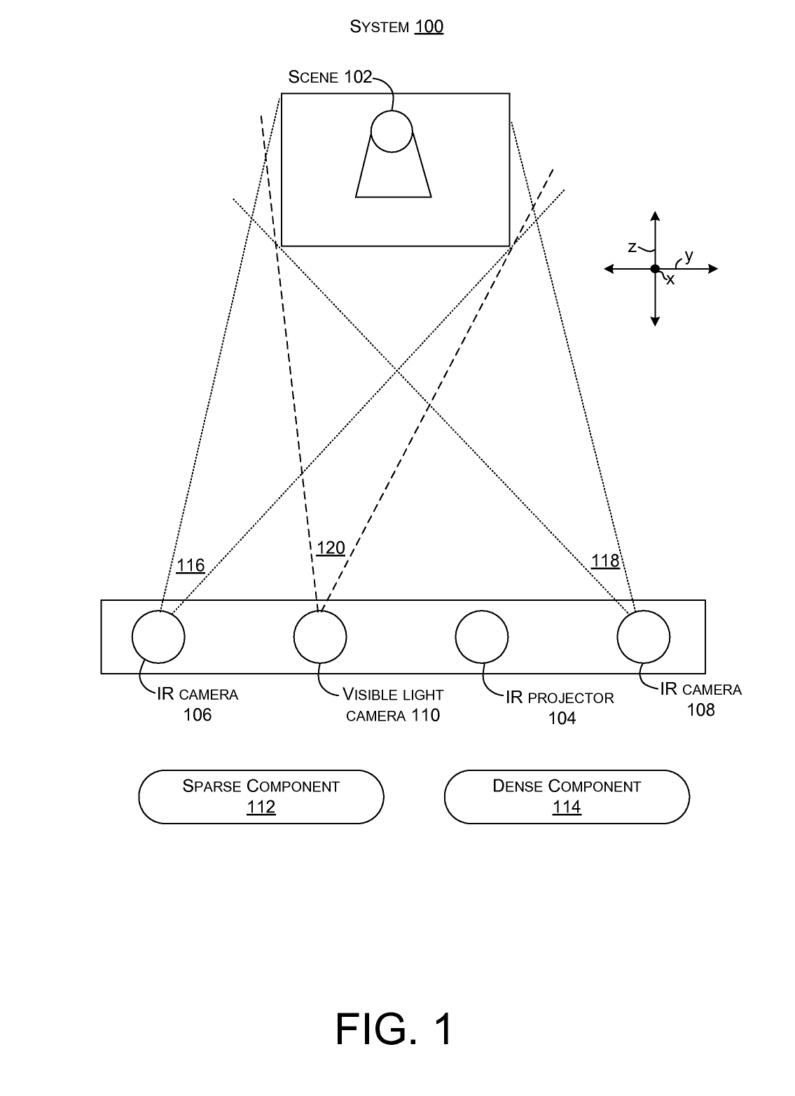

FIGS. 1-3 collectively show an example system 100 that can generate a depth map of a scene 102. In this configuration, system 100 includes an infrared (IR) projector 104 and two IR cameras 106 and 108. System 100 also includes a visible light camera 110, a sparse component 112, and a dense component 114. In this case, IR camera 106 is configured to capture an image 116 of scene 102 and IR camera 108 is configured to capture an image 118 of the scene. In a similar manner, visible light camera 110 is configured to capture an image 120 of the scene at wavelengths which are visible to a human eye.

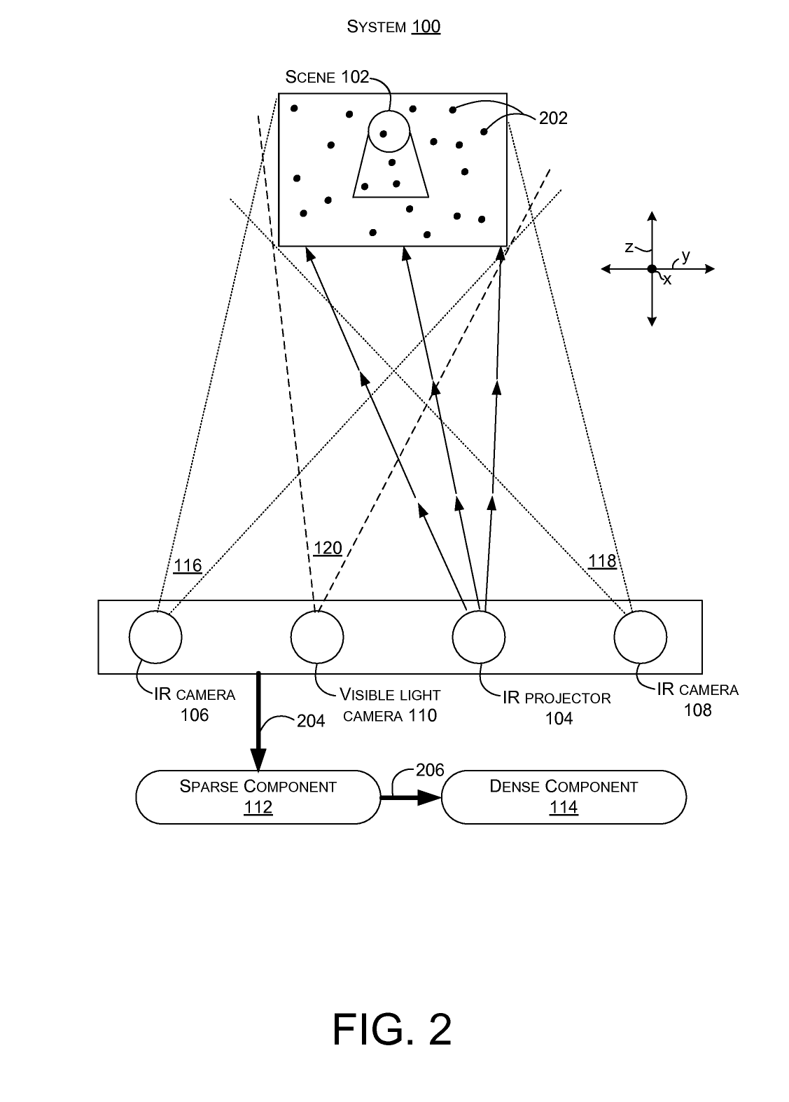

As can be evidenced from FIG. 2, the IR projector 104 can be configured to project features 202 (not all of which are specifically designated) onto scene 102. The features can be generated by a feature generator, such as a random feature generator for projection by the IR projector. The features can be any shape or size. Some implementations can utilize features in a range from about three to about five pixels, but this is only one example of feature size. The features can be detected by the two IR cameras 106 and 108. Of course, other types of energy can be used, such as ultraviolet UV light.

The IR projector 104 can serve to project features onto the scene that can be detected by the IR cameras 106 and 108. Any type of feature 202 can be utilized that serves this purpose. In some cases, the features are projected at random locations in the scene and/or at a random density. Examples of such features can include dots, geometric shapes, texture, etc. Dots are utilized in the described implementations, but any feature can be utilized that is readily detectable in the resulting IR images 116 and 118. In summary, features can be added to the scene rather than relying on the scene containing features that lend themselves to accurate location. Further, the added features are outside the visible spectrum and thus don't degrade image 120 of the scene captured by visible light camera 110. Other technologies could also satisfy this criteria. For instance UV light or other not-visible frequencies of light could be used.

The IR cameras 106 and 108, and visible light camera 110 may be genlocked, or synchronized. The genlocking of the IR cameras and/or visible light camera can ensure that the cameras are temporally coherent so that the captured stereo images directly correlate to each other. Other implementations can employ different numbers of IR projectors, IR cameras, and/or visible light cameras than the illustrated configuration.

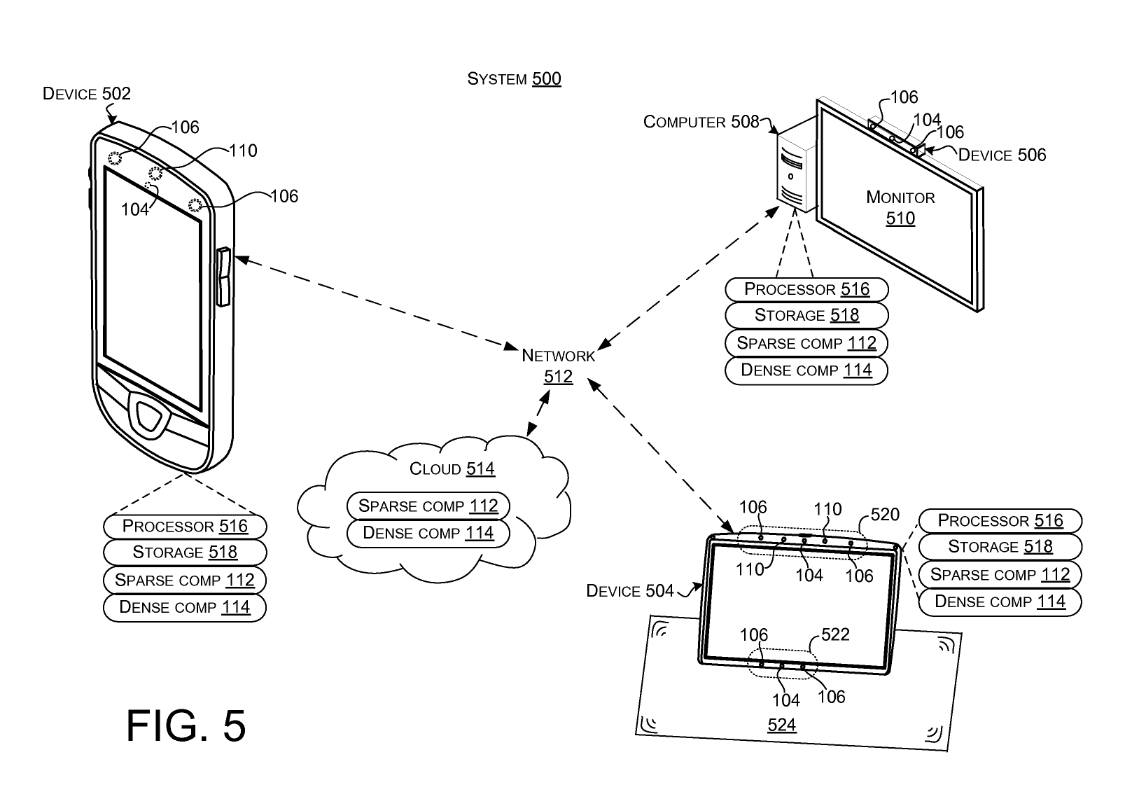

The visible light camera 110 can be utilized to capture a color image for the scene by acquiring three different color signals, i.e., red, green, and blue, among other configurations. The output of the visible light camera 110 can provide a useful supplement to a depth map for many applications and use case scenario, some of which are described below relative to FIG. 5.

The images 116 and 118 captured by the IR cameras 106 and 108 include the features 202. The images 116 and 118 can be received by sparse component 112 as indicated at 204. Sparse component 112 can process the images 116 and 118 to identify the depths of the features in the images from the two IR cameras. Thus, one function of the sparse component can be to accurately determine the depth of the features 202. In some cases, the sparse component can employ a sparse location-based matching technique or algorithm to find the features and identify their depth. The sparse component 112 can communicate the corresponding images and/or the feature depths to the dense component 114 as indicated at 206.

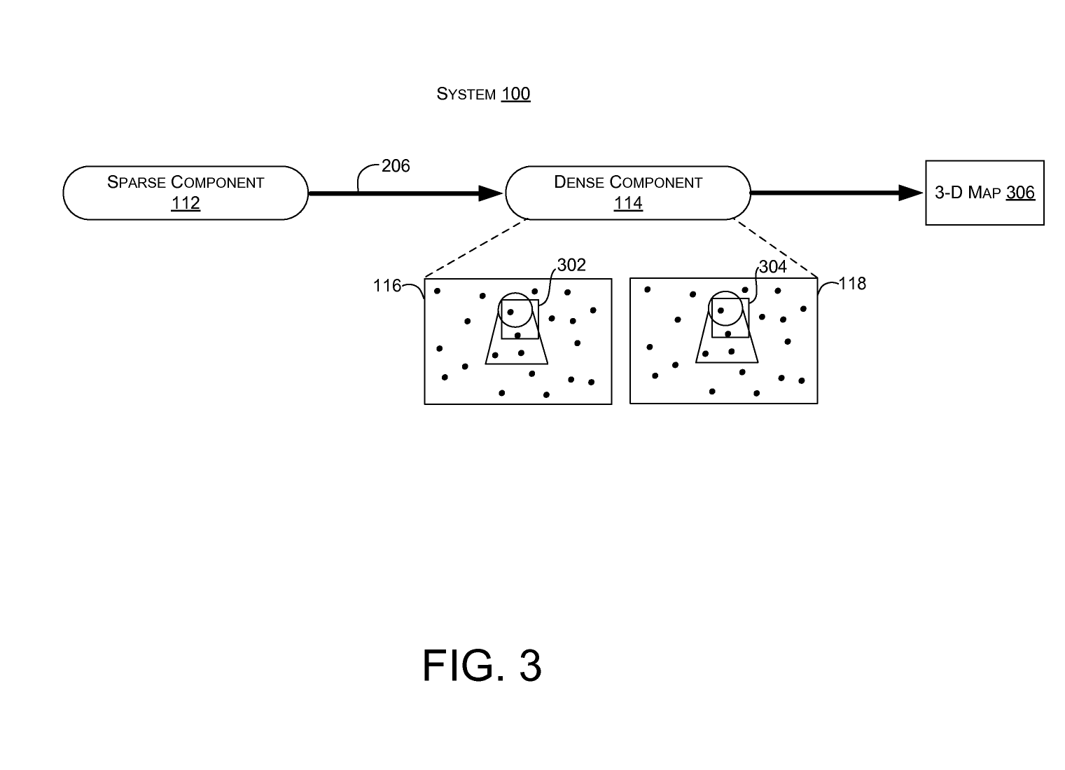

FIG. 3 shows a simplified illustration of dense component 114 further processing the images 116 and 118 in light of the feature depths. In some cases, the dense component can utilize a nearest neighbor field (NNF) stereo matching algorithm to further process the images. In this case, the dense component can analyze regions or patches 302 and 304 of the images for correspondence. In the illustrated case, the patches 302 and 304 include individual features (not labeled to avoid clutter on the drawing page). The depth of the features (provided by the sparse component 112) can serve as a basis for depths to explore for the patch. For example, the depth of individual features in the patch can serve as high (e.g., maximum) and/or low (e.g., minimum) depth values to explore for the patch. This facet is described in more detail below relative to the discussion under the heading “Third Method Example”. Based upon this processing the dense component 114 can produce a 3-D map of scene 102 from the images 116 and 118 as indicated at 306.

In summary, the present concepts can provide accurate stereo matching of a few features of the images. This can be termed ‘sparse’ in that the features tend to occupy a relatively small amount of the locations of the scene. These accurately known feature locations can be leveraged to initialize nearest neighbor field stereo matching of the imaging.

From one perspective, some of the present implementations can precisely identify a relatively small number of locations or regions in a scene. These precisely identified regions can then be utilized to initialize identification of the remainder of the scene.

### Second System Example

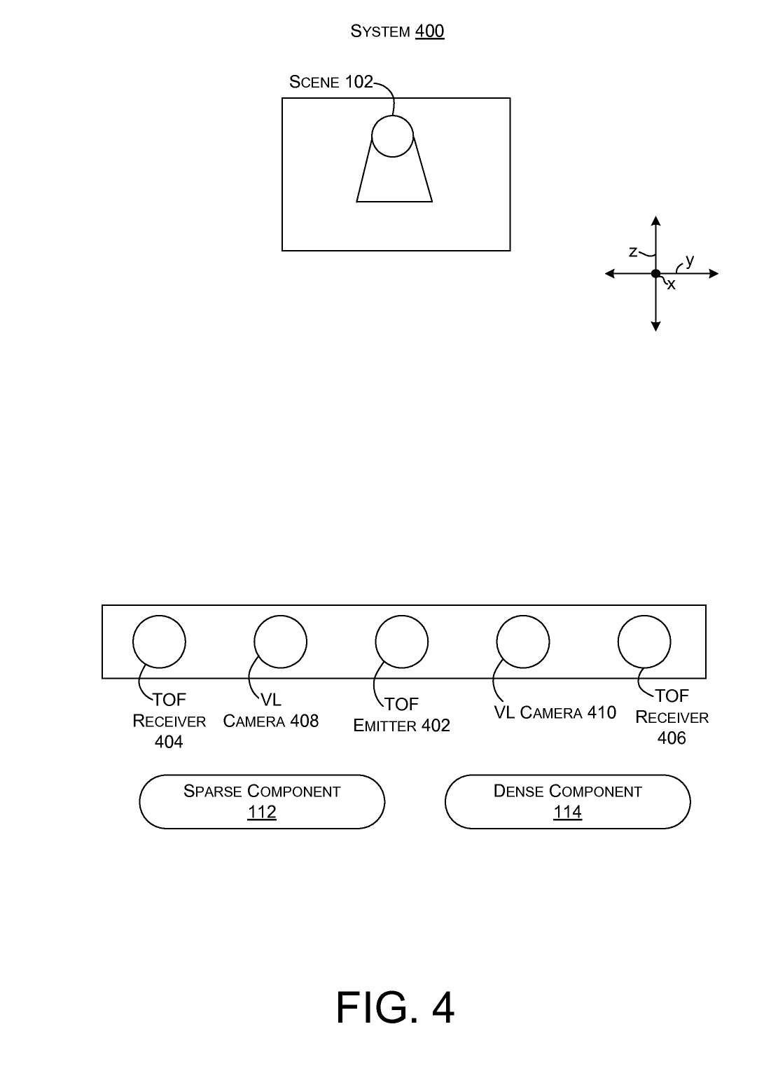

FIG. 4 shows an alternative system 400. In this case, scene 102, sparse component 112 and dense component 114 are retained from system 100. However, rather than projecting IR features onto scene 102 as described above relative to FIGS. 1-3, system 400 employs a time of flight (TOF) emitter 402, two TOF receivers 404 and 406, and two visible light cameras 408 and 410. The time of flight emitter and receivers can function to accurately determine the depth of specific locations of the scene. This information can then be utilized by the dense component to complete a 3-D mapping of images from the visible light cameras 408 and 410.

In an alternative configuration, the time of flight emitter 402 can be replaced with the IR projector 104 (FIG. 1) and the two TOF receivers 404 and 406 can be replaced by the IR cameras 106 and 108 (FIG. 1). The IR cameras and the visible light cameras can be temporally synchronized and mounted in a known orientation relative to one another. The IR projector can be configured to project random features on the scene 102. In such a case, the sparse component 112 can operate on IR images from the IR cameras. The sparse component can be configured to employ a sparse location-based matching algorithm to locate the features in the corresponding IR images and to determine depths of individual random features. The dense component can operate on visible images from the visible light cameras 408 and 410. The dense component can be configured to employ a nearest neighbor field (NNF) stereo matching algorithm to the corresponding visible images utilizing the depths of the individual random features to determine depths of pixels in the corresponding visible light images. Still other configurations are contemplated.

### Third System Example

FIG. 5 illustrates a system 500 that shows various device implementations of the present stereo matching concepts. Of course not all device implementations can be illustrated and other device implementations should be apparent to the skilled artisan from the description above and below. In this case, three device implementations are illustrated. Device 502 is manifest as a smart-phone type device. Device 504 is manifest as a pad or tablet type device. Device 506 is manifest as a freestanding stereo matching device that can operate in a stand-alone manner or in cooperation with another device. In this case, freestanding stereo matching device 506 is operating cooperatively with a desktop type computer 508 and a monitor 510. In this implementation, the monitor does not have a touch screen (e.g., is a non-touch-sensitive display device). Alternatively or additionally, the freestanding stereo matching device 506 could operate cooperatively with other types of computers, set top boxes, and/or entertainment consoles, among others. The device 502-506 can be coupled via a network 512. The network may also connect to other resources, such as the Cloud 514.

Devices 502, 504, and 506 can include several elements which are defined below. For example, these devices can include a processor 516 and/or storage 518. The devices can further include one or more IR projectors 104, IR cameras 106, visible light cameras 110, sparse components 112, and/or dense components 114. The function of these elements is described in detail above relative to FIGS. 1-4, as such, individual instances of these elements are not called out with particularity here for sake of brevity. The devices 502-506 can alternatively or additionally include other elements, such as input/output devices, buses, graphics cards (e.g., graphics processing units (GPUs)), etc., which are not illustrated or discussed here for sake of brevity.

Device 502 is configured with a forward facing (e.g., toward the user) IR projector 104, a pair of IR cameras 106, and visible light camera 110. This configuration can lend itself to 3-D video conferencing and gesture recognition (such as to control the device or for gaming purposes). In this case, corresponding IR images containing features projected by the IR projector 104 can be captured by the pair of IR cameras 106. The corresponding images can be processed by the sparse component 112 which can provide initialization information for the dense component. Ultimately, the dense component can generate a robust depth map from the corresponding images.

This depth mapping process can be performed for single pictures (e.g., still frames) and/or for video. In the case of video, the sparse component and the dense component can operate on every video frame or upon select video frames. For instance, the sparse component and the dense component may only operate on I-frames or frames that are temporally spaced, such as one every half-second for example. Thus, device 502 can function as a still shot ‘camera’ device and/or as a video camera type device and some or all of the images can be 3-D mapped.

Device 504 includes a first set 520 of IR projectors 104, IR cameras 106, and visible light cameras 110 similar to device 502. The first set can perform a functionality similar to the described above relative to device 502. Device 504 also includes a second set 522 that includes an IR projector 104 and a pair of IR cameras 106. This second set can be aligned to capture user ‘typing motions’ on surface 524 (e.g., a surface upon which the device is positioned). Thus, the second set can enable a virtual keyboard scenario.

Device 506 can be a free standing device that includes an IR projector 104, a pair of IR cameras 106, and/or visible light cameras 110. The device may be manifest as a set-top box or entertainment console that can capture user gestures. In such a scenario, the device can include a processor and storage. Alternatively, the device may be configured to enable monitor 510 that is not a touch screen to function as a ‘touchless touchscreen’ that detects user gestures toward the monitor without having to actually touch the monitor. In such a configuration, the device 506 may utilize processing and storage capabilities of the computing device 508 to augment or in place of having its own.

In still other configurations, any of devices 502-506 can send image data to Cloud 514 for remote processing by the Cloud's sparse component 112 and/or dense component 114. The Cloud can return the processed information, such as a depth map to the sending device and/or to another device with which the device is communicating, such as in a 3-D virtual conference.

The term “computer” or “computing device” as used herein can mean any type of device that has some amount of processing capability and/or storage capability. Processing capability can be provided by one or more processors (such as processor 516) that can execute data in the form of computer-readable instructions to provide a functionality. Data, such as computer-readable instructions, can be stored on storage, such as storage 518 that can be internal or external to the computer. The storage can include any one or more of volatile or non-volatile memory, hard drives, flash storage devices, and/or optical storage devices (e.g., CDs, DVDs etc.), among others. As used herein, the term “computer-readable media” can include signals. In contrast, the term “computer-readable storage media” excludes signals. Computer-readable storage media includes “computer-readable storage devices.” Examples of computer-readable storage devices include volatile storage media, such as RAM, and non-volatile storage media, such as hard drives, optical discs, and flash memory, among others.

In the illustrated implementation devices 502 and 504 are configured with a general purpose processor 516 and storage 518. In some configurations, a computer can include a system on a chip (SOC) type design. In such a case, functionality provided by the computer can be integrated on a single SOC or multiple coupled SOCs. One or more processors can be configured to coordinate with shared resources, such as memory, storage, etc., and/or one or more dedicated resources, such as hardware blocks configured to perform certain specific functionality. Thus, the term “processor” as used herein can also refer to central processing units (CPU), graphical processing units (CPUs), controllers, microcontrollers, processor cores, or other types of processing devices suitable for implementation both in conventional computing architectures as well as SOC designs.

In some configurations, the sparse component 112 and/or the dense component 114 can be installed as hardware, firmware or software during manufacture of the computer or by an intermediary that prepares the computer for sale to the end user. In other instances, the end user may install the sparse component 112 and/or the dense component 114, such as in the form of a downloadable application.

Examples of computing devices can include traditional computing devices, such as personal computers, desktop computers, notebook computers, cell phones, smart phones, personal digital assistants, pad type computers, cameras, or any of a myriad of ever-evolving or yet to be developed types of computing devices. Further, aspects of system 500 can be manifest on a single computing device or distributed over multiple computing devices.

### First Method Example

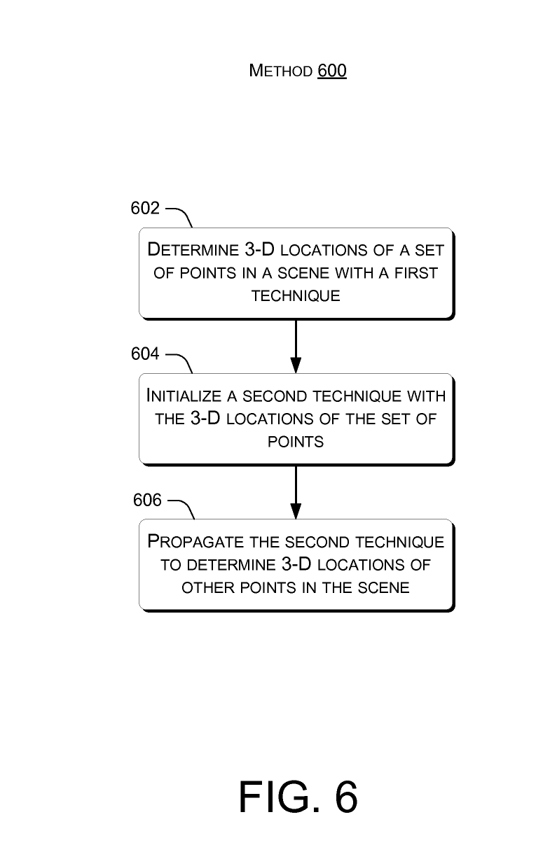

FIG. 6 shows an example scene depth matching method 600. In this case, a first technique can be used to determine depths of a set of points in a scene at block 602. The features of FIG. 2 provide one example of the set of points. A detailed explanation of an example of the first technique is described below relative to the second and third method examples.

A second technique can be initialized with the 3-D locations of the set of points at block 604. The second technique can be manifest as a nearest neighbor field (NNF) stereo matching technique. An example of an NNF stereo matching technique is Patch Match™, which is described in more detail below relative to the “Third Method Example”. Briefly, Patch Match can be thought of as an approximate dense nearest neighbor algorithm, i.e., for each patch of one image an (x, y)-vector can be mapped to a similar colored patch of a second image.

The second technique can be propagated to determine 3-D locations of other points of the scene at 606. The other points can be most or all of the remaining points of the scene. For example, in relation to FIG. 2, the other points can be all or nearly all of the points that are not covered by features 202. The combination of the first and second techniques can provide better results than can be achieved by either technique alone.

To summarize, the present implementations can accurately identify three-dimensional (3-D) locations of a few features or regions in the scene using a first technique. The identified three-dimensional locations can be utilized to initialize another technique that can accurately determine 3-D locations of a remainder of the scene.

### Second Method Example

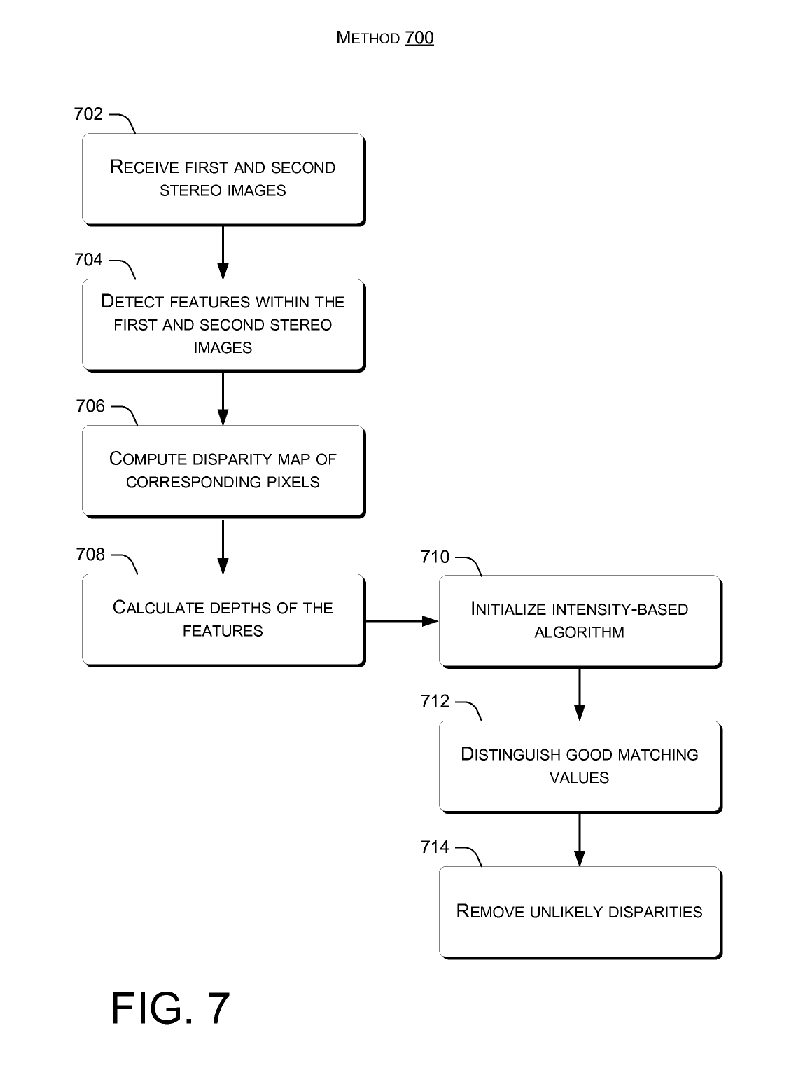

FIG. 7 shows an example scene depth matching method 700. In this case, first and second stereo images can be received at block 702.

Features can be detected within the first and second stereo images at block 704. Feature detection algorithms can be utilized to determine which pixels captured features. Some algorithms can even operate at a sub-pixel level and determine which portions of pixels captured features.

A disparity map can be computed of corresponding pixels that captured the features in the first and second stereo images at block 706.

Depths of the features can be calculated at block 708. One example is described below. Briefly, when the cameras are calibrated there can be a one-to-one relationship between disparity and depth.

An intensity-based algorithm can be initialized utilizing the feature depths at block 710. An example of an intensity-based algorithm is described below relative to the “Third Method Example”.

Good matching values can be distinguished at block 712. In one case, matching values can be compared to a threshold value. Those matching values that satisfy the threshold can be termed ‘good’ matching values, while those that do not satisfy the threshold can be termed ‘bad’ matching values.

Unlikely disparities can be removed at block 714. The removal can be thought of as a filtration process where unlikely or ‘bad’ matches are removed from further consideration.

### Third Method Example

The following implementation can operate on a pair of images (e.g., left and right images) to find correspondences between the images. The image pair may be captured either using two IR cameras and/or two visible-light cameras, among other configurations. Some implementations can operate on the assumption that the image pair has been rectified, such that for a pixel at location (x,y) in the left image, the corresponding pixel in the right image lies on the same row, i.e. at location (x+d,y). The technique can estimate disparity “d” for each pixel.

There is a one-to-one relationship between disparity and depth when the cameras are calibrated. Thus, an estimated disparity for each pixel can allow a depth map to be readily computed. This description only estimates a disparity map for the left image. However, it is equally possible to estimate a disparity map for the right image. The disparity d may be an integer, for a direct correspondence between individual pixels, or it may be a floating-point number for increased accuracy.

For purposes of discussion the left image is referred to as I_{L}. The sparse location-based matching technique can estimate a disparity map D for this image. The right image is referred to as I_{R}. A disparity D(x,y) can mean that the pixel I_{L}(x, y) in the left image corresponds to the point in the right image I_{R}(x+D(x, y),y).

### Intensity-Based Algorithm Example

An example intensity-based algorithm is manifest as the PatchMatch Stereo algorithm. An intensity-based algorithm can be thought of as being dense in that it can provide a depth map for most or all of the pixels in a pair of images. The PatchMatch Stereo algorithm can include three main stages: initialization, propagation, and filtering. In broad terms, the initialization stage can assign an initial disparity value to each pixel in the left image. The propagation stage can attempt to discover which of these initial values are “good”, and propagate that information to neighboring pixels that did not receive a good initialization. The filtering stage can remove unlikely disparities and labels those pixels as “unknown”, rather than pollute the output with poor estimates.

### Initialization

The PatchMatch Stereo algorithm can begin by assigning each pixel an initial disparity. The initial disparity can be chosen between some manually specified limits dₘᵢₙ and dₘₐₓ, which correspond to the (potentially) minimum and maximum depths in the scene.

The present implementation can leverage an approximate initial estimate of the 3-D scene, in the form of a sparse set of 3-D points, to provide a good initialization. These 3-D points can be estimated by, among other techniques, projecting a random dot pattern on the scene. The scene can be captured with a pair of infra-red cameras. Dots can be detected in the images from the pair of infra-red cameras and matched between images. These points can be accurate, reliable, and can be computed very fast. However they are relatively “sparse”, in the sense that they do not appear at many pixel locations in the image. For instance these points tend to occupy less than half of the total pixels in the images and in some implementations, these points tend to occupy less than 20 percent or even less than 10 percent of the total pixels.

The description above can serve to match the IR dots and compute their 3-D positions. Each point (e.g., dot) can be projected into the two images I_{L} and I_{R}, to obtain a reliable estimate of the disparity of any pixel containing a point. A naive approach could involve simply projecting each 3-D point (Xᵢ,Yᵢ,Zᵢ) to its locations (xᵢ^{L},yᵢ^{L}) and (xᵢ^{R},yᵢ^{R}) in the two images to compute its disparity dᵢ=xᵢ^{R}−xᵢ^{L} and set D(xᵢ^{L},yᵢ^{L})=dᵢ. However, not every pixel will contain a point, and some pixels may contain more than one point. In these cases, the points could either provide no information or conflicting information about a pixel's disparity.

The present implementation can retain the random initialization approach of the original PatchMatch Stereo algorithm, but which can be guided by a sparse 3-D point cloud. For each pixel (x, y) in the left image, the implementation can look to see if any 3-D points lie in a small square window (e.g., patch) around the pixel, and collect their disparities into a set Si={dᵢ_{₁},dᵢ_{₂}, . . . dᵢ_{_{K}}}. An initial disparity for the pixel can be chosen by sampling a value randomly between the minimum and maximum values in S. If no 3-D points are found nearby, this implementation can sample a value randomly between dₘᵢₙ, and dₘₐₓ. Listing 1 gives the high-level algorithm for choosing an initial disparity for a pixel.

Listing 1 Initialization of a pixel's disparity

```
    function Init Disparity (x,y,r,ptsL, ptsR)
        rect = RectRegion (x − r,x + r,y − r,y + r)
        near Pts = FindInRect (ptsL, rect)
        if nearPts.size > 0 then [symbol]
        Get min and max disparity of dots
    Dₘᵢₙ (x,y) = inf
        Dₘₐₓ (x,y) = −inf
for all i in nearPts do
        pL = ptsL[i]
    pR = ptsR[i]
    dᵢ = pR.x − pL.x
    Dₘᵢₙ (x,y) = min(dₘᵢₙ(x,y),dᵢ)
    Dₘₐₓ (x,y) = max(dₘₐₓ(x,y),dᵢ)
end for
        return rand (Dₘᵢₙ(x,y),Dₘₐₓ(x,y))
        else [symbol]
          No dots nearby, use global limits
        return rand (dₘᵢₙ,dₘₐₓ)
        end if
    end function
```

This initialization can begin by projecting all the 3-D points to their locations in the images. For each 3-D point (Xᵢ,Yᵢ,Zᵢ), the corresponding position-disparity triple (xᵢ^{L},yᵢ^{L},dᵢ) can be obtained. Various methods can be utilized to perform the pixel initializations. Two method examples are described below. The first method can store the list of position-disparity triples in a spatial data structure that allows fast retrieval of points based on their 2-D location. Initializing a pixel (x,y), can involve querying the data structure for all the points in the square window around (x,y), and form the set Sᵢ from the query results. The second method, can create two images in which to hold the minimum and maximum disparity for each pixel. These values are denoted as Dₘᵢₙ and Dₘₐₓ. All pixels can be initialized in Dₘᵢₙ to a large positive number, and all pixels in Dₘₐₓ to a large negative number. The method can iterate over the list of position-disparity triples. For each item (xᵢ^{L},yᵢ^{L},dᵢ), the method can scan over each pixel (xⱼ,yⱼ) in the square window around (xᵢ^{L},yᵢ^{L}), setting Dₘᵢₙ(xⱼ,yⱼ)=min(Dₘᵢₙ(xⱼ,yⱼ), dᵢ) and Dₘₐₓ(xⱼ,yⱼ)=max(Dₘₐₓ(xⱼ,yⱼ),dᵢ). This essentially “splats” each point into image space. Then, to initialize a disparity D(x,y), the method can sample a random value between Dₘᵢₙ(x,y) and Dₘₐₓ(x,y). If no points were projected nearby, then Dₘᵢₙ(x,y)>Dₘₐₓ(x,y), and sampling can be performed between dₘᵢₙ and dₘₐₓ.

### Propagation

After initializing each pixel with a disparity, the PatchMatch Stereo algorithm can perform a series of propagation steps, which aim to spread “good” disparities from pixels to their neighbors, over-writing “bad” disparities in the process. The general design of a propagation stage is that for each pixel, the method can examine some set of (spatially and temporally) neighboring pixels, and consider whether to take one of their disparities or keep the current disparity. The decision of which disparity to keep is made based on a photo-consistency check, and the choice of which neighbors to look at is a design decision. The propagation is performed in such an order that when the method processes a pixel and examines its neighbors, those neighbors have already been processed.

Concretely, when processing a pixel (x,y), the method can begin by evaluating the photo-consistency cost of the pixel's current disparity D(x,y). The photo-consistency cost function C(x,y,d) for a disparity d at pixel (x,y), can return a small value if I_{L}(x,y) has a similar appearance to I_{R}(x+d, y), and a large value if not. The method can then look at some set of neighbors N, and for each pixel (xₙ yₙ) in N, compute C(x,y,D (xₙ,yₙ)) and set D(x,y)=D (xₙ yₙ) if C(x,y,D(xₙ,yₙ))<C(x,y,D(x,y)). Note that the method is computing the photo-consistency cost of D(xₙ,yₙ) at (x, y), which is different from the photo-consistency cost of D(xₙ,yₙ) at (xₙ,yₙ). Pseudo-code for the propagation passes performed by some method implementations is given in Listing 2.

Listing 2 Temporal and spatial propagation of disparities

```
for all pixels (x,y) do PropagateTemporal(x,y)
end for
for all columns x do PropagateDown(x)
end for
for all rows y do PropagateRight(y)
end for
for all columns x do PropagateUp(x)
end for
for all rows y do PropagateLeft(y)
end for
function PROPAGATE TEMPORAL (x,y)
          d₁ = D(x,y) [symbol]
          D already holds disparities from previous frame
          d₂ = InitDisparity(x,y,r,ptsL, ptsR) [symbol]
          see Listing 1
          if C(x,y,d₂) < C(x,y,d₁) then
          D(x,y) = d₂
          end if
end function
function PROPAGATE DOWN (x) function  PROPAGATE RIGHT (y)
          for y = 1 to height −1 do
          d₁ = D(x,y)
          d₂ = D(x,y − 1)
          if C(x,y,d₂) < C(x,y,d₁) then
          D(x,y) = d₂
          end if
          end for
          end function
function PROPAGATE RIGHT (y)
          for x = 1 to width −1 do
          d₁ = D(x,y)
          d₂ = D(x − 1,y)
          if C(x,y,d₂) < C(x,y,d₁) then
          D(x,y) = d₂
          end if
          end for
          end function
```

### Photo-Consistency Cost Functions

A disparity ranking technique can be utilized to compare multiple possible disparities for a pixel and decide which is “better” and/or “best”. As in most intensity-based stereo matching, this can be done using a photo-consistency cost, which compares pixels in the left image to pixels in the right image, and awards a low cost when they are similar and a high cost when they are dissimilar. The (potentially) simplest photo-consistency cost can be to take the absolute difference between the colors of the two images at the points being matched, i.e. |I_{L}(x,y)−I_{R}(x+D(x,y),y)|. However, this is not robust, and may not take advantage of local texture, which may help to disambiguate pixels with similar colors.

Instead, another approach involves comparing small image patches centered on the two points. The width w of the patch can be set manually. This particular implementation utilizes a width of 11 pixels, which can provide a good balance of speed and quality. Other implementations can utilize less than 11 pixels or more than 11 pixels. There are many possible cost functions for comparing image patches. Three examples can include sum of squared differences (SSD), normalized cross-correlation (NCC) and Census. These cost functions can perform a single scan over the window, accumulating comparisons of the individual pixels, and then use these values to compute a single cost. One implementation uses Census, which is defined as

$${C}_{Census} ( x , y , d ) = {\sum }_{{x}_{j} = x - r}^{x + r} {\sum }_{{y}_{j} = y - r}^{y + r} ( {I}_{L} ( {x}_{j} , {y}_{j} ) > {I}_{L} ( x , y ) ) \neq ( {I}_{R} ( {x}_{j} + d , {y}_{j} ) > {I}_{R} ( x + d , y ) ) . \qquad ( 1 )$$

There are two final details to note, regarding the photoconsistency score/patch comparisons relative to at least some implementations. First, not every pixel in the patch may be used. For speed, some implementations can skip every other column of the patch. This can reduce the number of pixel comparisons by half without reducing the quality substantially. In this case, x; iterates over the values {x−r,x−r+2, . . . , x+r−2,x+r}. Second, disparities D(x, y) need not be integer-valued. In this case, an image I_{R}(xⱼ+D(X y),yⱼ) is not simply accessed in memory, but is interpolated from neighboring pixels using bilinear interpolation. This sub-pixel disparity increases the accuracy of the final depth estimate.

### Temporal Propagation

When processing a video sequence, the disparity for a pixel at one frame may provide a good estimate for the disparity at that pixel in the next frame. Thus at frame t, the propagation stage can begin with a temporal propagation that can consider the disparity from the previous frame D^{t-1}(x,y) and can take this disparity if it offers a lower photo-consistency cost. In practice, when a single array is used to hold the disparity map for all frames, the temporal propagation can be swapped with the initialization. In this way, all pixels can start with their disparity from the previous frame. The photo-consistency cost of a random disparity can be computed for each pixel. The photo-consistency cost can be utilized if it has a lower cost than the temporally-propagated disparity. Pseudo-code for this is given in Listing 2, under PropagateTemporal.

### Spatial Propagation

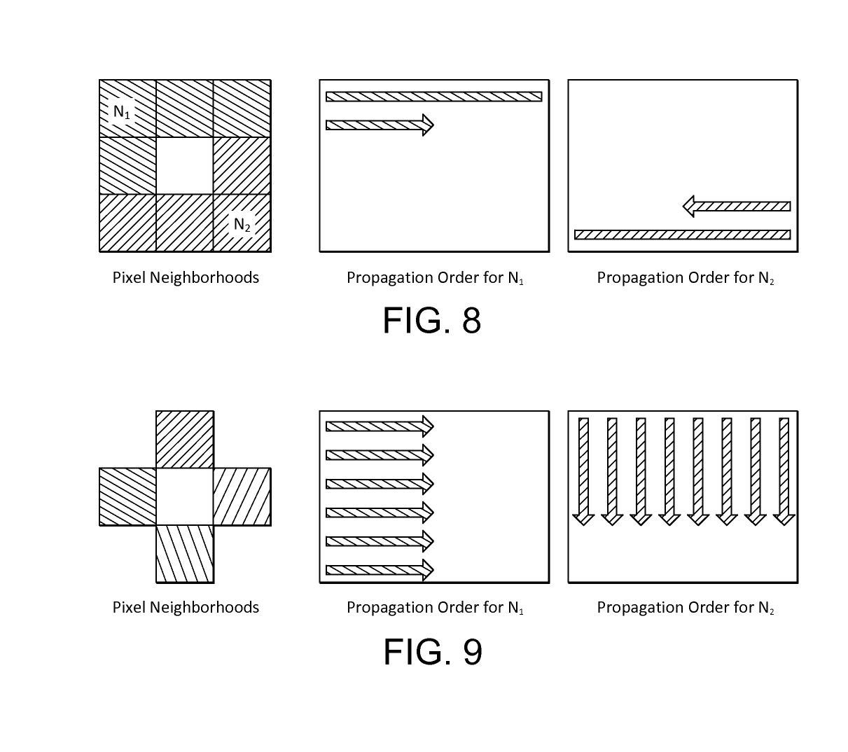

Following the temporal propagation, the method can perform several passes of spatial propagation. In some variations of the PatchMatch Stereo algorithm, two spatial propagation passes are performed, using two different neighborhoods with two corresponding pixel orderings. The neighborhoods are shown in FIG. 8 as N₁ and N₂, with the corresponding propagation orderings. The propagations can be sequential in nature, processing a single pixel at a time, and the algorithm alternates between the two propagation directions.

Stated another way, in an instance where the images are frames of video, a parallel propagation scheme can be employed on the video frames. In one case, the parallel propagation scheme can entail propagation from left to right and top to bottom in parallel for even video frames followed by temporal propagation and propagation from right to left and bottom to top in parallel for odd video frames. Of course, other configurations are contemplated.

Some implementations of PatchMatch Stereo can run on the graphics processing unit (GPU) and/or the central processing unit (CPU). Briefly, GPUs tend to perform relatively more parallel processing and CPUs tend to perform relatively more sequential processing. In the GPU implementation of PatchMatch Stereo, different neighborhoods/orderings can be used to take advantage of the parallel processing capabilities of the GPU. In this implementation, four neighborhoods are defined, each consisting of a single pixel, as shown in FIG. 9. Using these neighborhoods, whole rows and columns can be processed independently on separate threads in the GPU. The algorithm cycles through the four propagation directions, and in the current implementation, each direction is run only once per frame. Note that in this design there is no diagonal spatial propagation, although this could be added by looking at the diagonal neighbors when performing the vertical and horizontal propagations.

### Additional Comparisons

After the propagation, each pixel will have considered several possible disparities, and retained the one which gave the better/best photo-consistency between left and right images. In general, the more different disparities a pixel considers, the greater its chances of selecting an accurate disparity. Thus, it can be attractive to consider testing additional disparities, for example when testing a disparity d also testing d±0.25, d±0.5, d±1. These additional comparisons can be time-consuming to compute however.

On the GPU, the most expensive part of computing a photo-consistency cost can be accessing the pixel values in the right image. For every additional disparity d′ that is considered at a pixel (x,y), the method can potentially access all the pixels in the window around I_{R}(x+d′,y). This aspect can make processing time linear in the number of disparities considered. However, if additional comparisons are strategically selected that do not incur any additional pixel accesses, they will be very cheap and may improve the quality. One GPU implementation can cache a section of the left image in groupshared memory as all of the threads move across it in parallel. As a result, it can remain expensive for a thread to access additional windows in the right image, but becomes cheap to access additional windows in the left image. Thus, a thread whose main task is to compute C(x,y,d), can also cheaply compute C(x−1,y,d+1), C(x+1,y,d−1) etc. and then “propose” them back to the appropriate threads via an additional block of groupshared memory.

### Filtering

The final stage in the PatchMatch Stereo algorithm can be filtering to remove spurious regions that do not represent real scene content. This is based on a simple region labeling algorithm, followed by a threshold to remove regions below a certain size. A disparity threshold t_{d} can be defined. Any two neighboring pixels belong to the same region if their disparities differ by less than t_{d}, i.e. pixels (x₁,y₁) and (x₂,y₂) belong to the same region if |D(x₁,y₁)−D(x₂,y₂)|<t_{d}. In some implementations, t_{d}=2. This definition can enable the extraction of all regions and discard all regions smaller than 200 pixels, setting their disparity to “unknown”.

In summary, the described concepts can employ a two-stage stereo technique where the first stage computes depth at highly accurate but sparse feature locations. The second stage computes a dense depth map using the first stage as initialization. This can improve accuracy and robustness of the dense depth map.

The methods described above can be performed by the systems and/or devices described above relative to FIGS. 1, 2, 3, 4, and/or 5, and/or by other devices and/or systems. The order in which the methods are described is not intended to be construed as a limitation, and any number of the described acts can be combined in any order to implement the method, or an alternate method. Furthermore, the method can be implemented in any suitable hardware, software, firmware, or combination thereof, such that a device can implement the method. In one case, the method is stored on computer-readable storage media as a set of instructions such that execution by a computing device causes the computing device to perform the method.

### CONCLUSION

Although techniques, methods, devices, systems, etc., pertaining to stereo imaging are described in language specific to structural features and/or methodological acts, it is to be understood that the subject matter defined in the appended claims is not necessarily limited to the specific features or acts described. Rather, the specific features and acts are disclosed as exemplary forms of implementing the claimed methods, devices, systems, etc.

1. A system, comprising:
a processor configured to receive corresponding images of a scene from a pair of cameras, the corresponding images including features added to the scene at wavelengths of light not visible to the human eye;
the processor configured to implement a sparse component configured to employ a sparse location-based matching algorithm to locate the features in the corresponding images and to determine depths of individual features; and,
the processor configured to implement a dense component configured to employ a nearest neighbor field (NNF) stereo matching algorithm to the corresponding images utilizing the depths of the individual features to find corresponding pixels in the corresponding images.

2. The system of claim 1, wherein the system includes the pair of cameras.

3. The system of claim 2, wherein the system further includes at least one visible light camera.

4. The system of claim 1, wherein the wavelengths of light not visible to the human eye are infrared (IR) wavelengths and the pair of cameras are infrared (IR) cameras.

5. The system of claim 4, further comprising an IR projector configured to project the features on the scene.

6. The system of claim 5, wherein the IR projector includes a random feature generator, and wherein the features have a width of about 3 to about 5 pixels in the pair of IR cameras.

7. The system of claim 1, wherein the processor, the sparse component, and the dense component are manifest as a system on a chip.

8. The system of claim 1, wherein the processor is manifest as a central processing unit or a graphics processing unit.

9. The system of claim 1, wherein the system is manifest as a single device.

10. A method, comprising:
determining three-dimensional (3-D) locations of a set of points in a scene with a first technique;
initializing a second technique with the 3-D locations of the set of points; and,
propagating the second technique to determine 3-D locations of other points in the scene.

11. The method of claim 10, wherein the determining comprises:
receiving first and second stereo images;
detecting features within the first and second stereo images;
computing a disparity map of corresponding pixels that captured the features in the first and second stereo images; and,
calculating depths of the features and wherein the features comprise the points.

12. The method of claim 11, wherein the initializing comprises utilizing the depths of the 3-D locations of individual points as a basis for selecting initial minimum and maximum depths for patches of pixels that contain the individual points.

13. The method of claim 11, wherein the first technique comprises a sparse location-based matching technique and the second technique comprises a nearest neighbor field (NNF) stereo matching technique.

14. A device, comprising:
an infrared (IR) projector configured to project features onto a scene in a random pattern;
at least first and second IR cameras configured to capture corresponding images of the scene;
a first component configured to determine depths of the features in the corresponding images; and,
a second component configured to utilize the determined depths of the features to construct a disparity map between the corresponding images.

15. The device of claim 14, wherein the first component is configured to determine individual pixels on the corresponding images that capture individual features.

16. The device of claim 14, wherein the second component is configured to utilize the determined depths of individual pixels as a basis for selecting potential minimum and maximum depths of patches of pixels in the corresponding images.

17. The device of claim 14, wherein the first component further comprises a feature detector configured to detect an individual feature in the corresponding images and to determine which pixels in the first and second IR cameras captured the individual feature.

18. The device of claim 14, further comprising at least one visible light camera that is synchronized with the at least first and second IR cameras.

19. The device of claim 18, wherein the at least one visible light camera and the at least first and second IR cameras are all video cameras.

20. The device of claim 14, wherein the device is manifest as a smart phone, a pad type computer, a notebook type computer, a set top box, an entertainment console, or a device configured to operate in cooperation with a non-touch-sensitive display device to record user gestures relative to the non-touch-sensitive display device.

21. A system, comprising:
an infrared (IR) projector configured to project random features on a scene;
a pair of IR cameras configured to capture corresponding IR images of the scene and the random features;
a pair of visible light cameras configured to capture corresponding visible light images of the scene;
a sparse component configured to employ a sparse location-based matching algorithm to locate the features in the corresponding IR images and to determine depths of individual random features; and,
a dense component configured to employ a nearest neighbor field (NNF) stereo matching algorithm to the corresponding visible images utilizing the depths of the individual random features to determine depths of pixels in the corresponding visible light images.
